(19) United States
(12) Patent Application Publication
(10) Pub. No.: US 2026/0270586 A1
(43) Pub. Date: Sep. 10, 2026

(54) IMAGE SENSOR CONTROL CIRCUITRY, IMAGE SENSOR, IMAGE SENSOR CONTROL METHOD

(71) Applicant: Sony Semiconductor Solutions Corporation, Atsugi-shi, Kanagawa (JP)

(72) Inventors: Matteo PERENZONI, Stuttgart (DE); Daniele GIORGETTI, Stuttgart (DE); Daniele PERENZONI, Stuttgart (DE); Francescopaolo MATTIOLI DELLA ROCCA, Stuttgart (DE); David STOPPA, Stuttgart (DE)

(73) Assignee: Sony Semiconductor Solutions Corporation, Atsugi-shi, Kanagawa (JP)

(21) Appl. No.: 19/165,283

(22) PCT Filed: Mar. 12, 2024
(86) PCT No.: PCT/EP2024/056500

§ 371 Date: Sep. 15, 2025

(30) Foreign Application Priority Data
Mar. 24, 2023 (EP) 23164133.3

(51) Int. Cl. H04N 25/705; H04N 25/443; H04N 25/773; H04N 25/78

(52) U.S. Cl. CPC H04N 25/705; H04N 25/443; H04N 25/773; H04N 25/78

(57) ABSTRACT

The present disclosure generally pertains to image sensor control circuitry for controlling a plurality of pixels of an image sensor for defining a macro pixel and routing a signal of the macro pixel to a sensor periphery, the circuitry including: a plurality of first level signal lines, wherein each first level signal line is provided for at least two pixels of the image sensor, thereby defining a first level pixel tile; and a plurality of second level signal lines, wherein each second level signal line is provided for at least two first level pixel tiles of the image sensor, thereby defining a second level pixel tile.

### TECHNICAL FIELD

The present disclosure generally pertains to image sensor control circuitry, an image sensor, and to an image sensor control method.

### TECHNICAL BACKGROUND

Generally, methods for providing macro pixels in image sensor are known.

In such methods, image sensors may perform in-pixel integration and scanning readout in order to deliver output data.

For example, in dTOF (direct time-of-flight) sensors, the information to retain may correspond to an echo arrival time (or roundtrip delay; which may be encoded into an electrical pulse or edge) which might have to be resolved with sub-nanoseconds precision.

In small sensor arrays it may be possible to measure it in-pixel, using per-pixel small time-to-digital converters (TDC). However, high-resolution and small-pixel array may lead to the situation that TDCs may have to be moved to a sensor periphery and thus, become less in number with respect to the pixels.

Moreover, laser dots may be used instead of flood illumination to achieve a better illumination power density: each dot may be projected onto the scene and imaged onto the image sensor, encompassing from a single pixel area to groups of two times two pixels, to larger pixel groups, each one defined as a macro pixel.

Such macro pixels may be considered to carry a single distance information, even though multiple distances are not excluded. The macro pixels positions may be scattered over a focal plane, potentially change with distance, and lens distortion may play a role. It is known to calibrate a sensor in advance, but macro pixel positions may remain potentially arbitrary.

Moreover, it is known to selectively activate zones or rows of a sensor to compensate for such distortions.

Although there exist techniques for determining macro pixels, it is generally desirable to provide image sensor control circuitry, an image sensor, and an image sensor control method.

### SUMMARY

According to a first aspect, the disclosure provides image sensor control circuitry for controlling a plurality of pixels of an image sensor for defining a macro pixel and routing a signal of the macro pixel to a sensor periphery, the circuitry comprising:
a plurality of first level signal lines, wherein each first level signal line is provided for at least two pixels of the image sensor, thereby defining a first level pixel tile; and
a plurality of second level signal lines, wherein each second level signal line is provided for at least two first level pixel tiles of the image sensor, thereby defining a second level pixel tile

According to a second aspect, the disclosure provides an image sensor comprising:
a plurality of pixels;
a plurality of first level signal line nodes for connecting at least two pixels of the plurality of pixels with first level signal lines, thereby defining a first level pixel tile; and
a plurality of second level signal line nodes for connecting at least two first level pixel tiles with second level signal lines, thereby defining a second level pixel tile.

According to a third aspect, the disclosure provides an image sensor control method for controlling a plurality of pixels of an image sensor for defining a macro pixel and routing a signal of the macro pixel to a sensor periphery, the method being carried out with image sensor control circuitry comprising a plurality of first level signal lines, wherein each first level signal line is provided for at least two pixels of the image sensor, thereby defining a first level pixel tile; and a plurality of second level signal lines, wherein each second level signal line is provided for at least two first level pixel tiles of the image sensor, thereby defining a second level pixel tile, the method comprising:
generating an activation signal for activating the second level pixel tile.

Further aspects are set forth in the dependent claims, the drawings and the following description.

### BRIEF DESCRIPTION OF THE DRAWINGS

Embodiments are explained by way of example with respect to the accompanying drawings, in which:

FIG. 1 depicts different levels of pixel tiles according to the present disclosure;

FIG. 2 a depicts an embodiment of an image sensor with an example of a 3×3 macro pixel according to the present disclosure;

FIG. 2b, a more detailed view of pixel tiles of the image sensor of FIG. 2a is shown;

FIG. 3 depicts a schematic diagram of a horizontal and vertical bus system according to the present disclosure;

FIG. 4 depicts a further embodiment of an image sensor according to the present disclosure and an embodiment of image sensor control circuitry according to the present disclosure, which is based on toggling pixels (information on edges) and XOR gates as logic circuitry;

FIG. 5 depicts a further embodiment of an image sensor according to the present disclosure and an embodiment of image sensor control circuitry according to the present disclosure, which is based on pulsing pixels (information on pulses) and OR gates as logic circuitry;

FIG. 6 depicts different macro pixel patterns and pixel tiles definitions according to the present disclosure corresponding to an ROI;

FIG. 7 depicts an image sensor according to the present disclosure;

FIG. 8 depicts an image sensor according to the present disclosure with overlapping second level pixel tiles;

FIG. 9 depicts an image sensor control method according to the present disclosure; and

FIG. 10 depicts a schematic view of an embodiment of a smart phone which functions as a ToF camera including an image sensor according to the present disclosure and image sensor control circuitry according to the present disclosure.

### DETAILED DESCRIPTION OF EMBODIMENTS

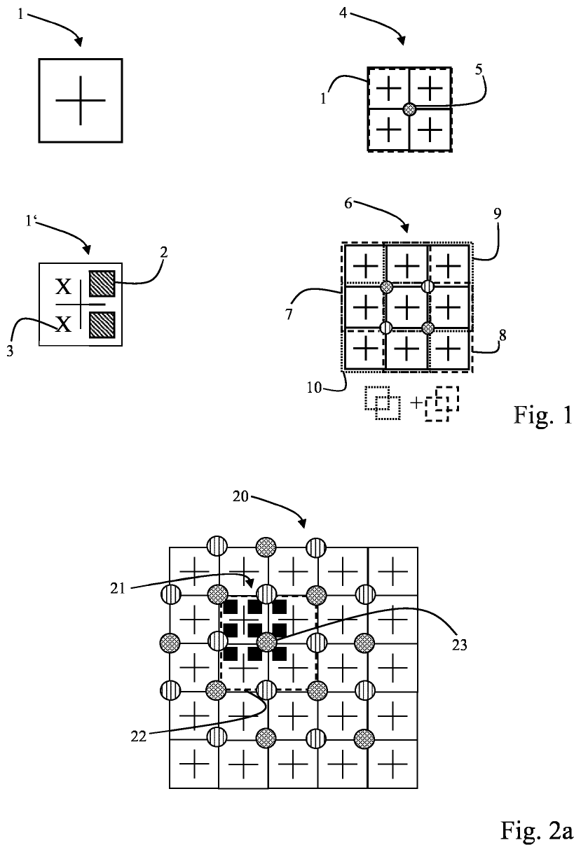

Before a detailed description of the embodiments starting with FIG. 1 is given, general explanations are made.

As mentioned in the outset, it is known to provide pixel tiles based on single pixels in an image sensor. However, it has been recognized that there might be a connectivity and bandwidth bottleneck in known image sensor architectures when time-critical digital information should be delivered from pixels to processing circuitry.

Hence, it has been recognized that it may be desirable to redirect signals from arbitrarily distributed pixels groups (macropixels), within an array, to a limited number of readout/processing resources located at a periphery (due to size constraints). Such a connection may have a requirement of being simultaneous and fully parallel, i.e., no sequential scanning or addressing should be carried out, in some embodiments.

For example, in direct time-of-flight (dTOF) sensors, single photon detection signals may be generated by pixels illuminated based on an image of projected dots. In such sensors, time-to-digital converters (TDC) may be placed at the periphery and it may be desirable to synchronously readout the pixels and deliver a signal to the respective TDCs.

It has been recognized that this may be achieved by implementing an architecture that locally compresses (through logic functions or merging methods (e.g., AND, OR, XOR, SUM)) the digital signals and then flexibly delivers it to a readout/processing resource at the periphery via a multilevel hierarchy. Moreover, it has been recognized that a horizontal/vertical bus combination may be used for resources conflict mitigation which may arise due to the multilevel hierarchy.

Moreover, it has been recognized to calibrate (or self-identify) pixel tiles and to transfer time information from the pixel tiles to an available TDC at a periphery, while optimizing wiring and bandwidth requirements, and enabling a flexible pixel allocation to prevent conflicts (i.e., different pixel tiles should not be connected to the same bus line or TDC, or the like).

It has further been recognized that it may be desirable to provide an image sensor which may provide for a flexible pixel tile size, pattern, and position, for a high resource efficiency, which may be easy to configure, and which may provide multiple degrees of freedom for solving conflicts.

Therefore, some embodiments pertain to image sensor control circuitry for controlling a plurality of pixels of an image sensor for defining a macro pixel and routing a signal of the macro pixel to a sensor periphery, the circuitry comprising: a plurality of first level signal lines, wherein each first level signal line is provided for at least two pixels of the image sensor, thereby defining a first level pixel tile; and a plurality of second level signal lines, wherein each second level signal line is provided for at least two first level pixel tiles of the image sensor, thereby defining a second level pixel tile.

Circuitry may include any entity or multitude of entities which may be configurable such that signals (e.g., electric signals) may be transmitted by or through the circuitry. For example, the circuitry may be based on a processor, such as a CPU (central processing unit), GPU (graphics processing unit), based on an FPGA (field-programmable gate array), or the like.

The circuitry may be provided for controlling a plurality of pixels of an image sensor. Hence, the circuitry may be part of the image sensor or may be a separate entity, which may be connectable to the image sensor.

Pixels may correspond to any (single) unit which may be used for imaging and may be based on semiconductor technology, such as CCD (charge coupled device), CMOS (complementary metal oxide semiconductor), or the like. Although the embodiments which are described with the figures pertain to SPADs (single photon avalanche diode), the present disclosure should not be understood as limited to such an implementation as any type of pixel or imaging technology may be utilized according to the present disclosure, such as event sensing, color imaging, 2D imaging, 3D imaging, infrared (IR) imaging, short-wave infrared (SWIR) imaging, terahertz (THz) imaging, multi-spectral imaging, or the like.

According to the present disclosure, one or multiple macro pixels (e.g., region of interest, pixel patterns, or the like, wherein at least two pixels are grouped for this purpose) may be defined and a signal generated by the defined macro pixel may be routed to a sensor periphery (e.g., any circuitry which processes the macro pixel's signal).

In some embodiments, the image sensor control circuitry includes signal lines of different levels, such as first level signal lines and a second level signal lines.

The first level signal lines may be provided for single pixels and signals may be transmitted through the first level signal lines which may be indicative of reading out the single pixel, of activating or deactivating the single pixel, or the like. Moreover, the first level signal lines may define a pixel tile, i.e., at least one first level signal line may be provided for at least two single pixels.

In the following, to such a pixel tile, it will be referred to as first level pixel tile.

The second level signal lines may be provided for single first level pixel tiles, i.e., for at least two first level pixel tiles. The second level signal lines may be used for transmitting signals which may be indicative of reading out the first level pixel tile, activating it, deactivating it, or the like. Hence, based on the second level signal lines, second level pixel tiles may be defined.

In some embodiments, the second level pixel tiles may overlap, i.e., may partially include the same pixels, as will be discussed below (L2 tiles).

It should be understood that, based on a similar principle, third level pixel tiles, fourth level pixel tiles, and so on, may be defined.

According to the present disclosure, it may be possible to reduce the total amount of signal lines (e.g., instead of one line per single pixel), while at the same time increasing the possibilities of flexibly configuring different pixel tile layouts.

In some embodiments, the circuitry is configured to: generate an activation signal for activating the second level pixel tile.

For example, to define which pixels belong and contribute, with their signals, to a pixel tile, the second level (or third level, or the like) pixel tile may be used. For example, in a layout of two times two first level pixel tiles, wherein each first level pixel tile includes two times two single pixels, a predetermined pattern of single pixels may be deactivated (or not activated, or not controlled, or the like), such that for reading out this pattern, the second level pixel tile may be activated.

In some embodiments, the image sensor control circuitry further includes: a plurality of third level signal lines, wherein each third level signal line is provided for at least two second level pixel tiles of the image sensor, thereby defining a third level pixel tile, as discussed herein.

A deactivated pixel may be established by actively deactivating the pixel, e.g., based on a deactivation signal, or by passively not reading it out, e.g., by not applying a voltage to it, or the like.

Hence, in some embodiments, the image sensor control circuitry is configured to: deactivate at least one single pixel of the first level pixel tile for further defining the second level pixel tile.

In some embodiments, the image sensor control circuitry is configured to: generate a definition signal for defining the second level pixel tile.

For example, the definition signal may be configured to activate and/or deactivate particular pixels, i.e., the definition signal may correspond to the deactivation signal and/or to an activation signal, depending on a state of the single pixels of the sensor. For example, if all the pixels are turned off (e.g., as a default state), the definition signal may define a pattern of pixels which should be active, such that, in response to the definition signal, these pixels are activated.

On the other hand, if all pixels are turned on (e.g., as a default state), the definition signal may define a (similar or different) pattern of pixels which should be active such that all the other pixels are turned off, in response to the definition signal.

In some embodiments, if a subset of pixels are turned off and another subset of pixels are turned on, the pattern defined by the definition signal may be realized by turning off some of the turned-on pixels and by turning on some of the turned-off pixels.

In some embodiments, the definition signal is based on a logic function.

The logic function may be based on a single or multiple basic logic functions, such as OR, NOR, XOR, AND, or the like. Multiple basic logic functions may be combined, as commonly known to the skilled person. A first or second (or third, and so on) level pixel tile may be read out based on the logic function. For example, if two single pixels defining a first level pixel tile must pass an AND function, both pixels may need to deliver a HIGH signal for the first level pixel tile to deliver a HIGH signal.

The logic function may be based on a single or multiple (basic) logic functions in which an activation status of one or multiple pixels may be input, such as OR, NOR, XOR, AND, or the like. Multiple basic logic functions may be combined, as commonly known to the skilled person. A first or second (or third, and so on) level pixel tile may be defined and configured to read out based on the logic function. For example, the definition signal of a second level tile might be the AND function of all pixels of its top-left first level tile for the case of a 3×3 macropixel configuration.

In some embodiments, the first level signal lines constitute a combination system.

In some embodiments, the image sensor control circuitry further includes first level combination circuitry and second level combination circuitry being different for the first level signal lines and the second level signal lines.

For example, different readout logic may be used for the first level signal lines, i.e., for the first level pixel tile than for the second level pixel tile, as will be discussed further below.

Some embodiments pertain to an image sensor including: a plurality of pixels; a plurality of first level signal line nodes for connecting at least two pixels of the plurality of pixels with first level signal lines, thereby defining a first level pixel tile; and a plurality of second level signal line nodes for connecting at least two first level pixel tiles with second level signal lines, thereby defining a second level pixel tile.

In some embodiments, the image sensor further includes the image sensor control circuitry, as discussed herein. However, the present disclosure is not limited to that case since the image sensor control circuitry may be a different entity than the image sensor. For example, in case of a stacked implementation, the control circuitry may be provided on a different wafer than the actual image sensor.

In some embodiments, the image sensor is configured to: generate an activation signal for activating the second level pixel tile, as discussed herein. In some embodiments, the first level signal lines and the second level signal lines constitute a combination system, as discussed herein. In some embodiments, the image sensor further includes first level combination circuitry and second level combination circuitry being different for the first level signal lines and the second level signal lines, as discussed herein. In some embodiments, the image sensor further includes: a plurality of third level signal line nodes, wherein each third level signal line node is provided for at least two second level pixel tiles of the image sensor, thereby defining a third level pixel tile; and a plurality of third level signal lines for connecting the at least two second level pixel tiles with the third level signal line node, as discussed herein. In some embodiments, the image sensor is configured to: deactivate at least one single pixel of the first level pixel tile for further defining the second level pixel tile, as discussed herein. In some embodiments, the image sensor is configured to: generate a definition signal for defining the second level pixel tile, as discussed herein. In some embodiments, the definition signal is based on a logic function, as discussed herein.

Some embodiments pertain to an image sensor control method for controlling a plurality of pixels of an image sensor for defining a macro pixel and routing a signal of the macro pixel to a sensor periphery, the method being carried out with image sensor control circuitry comprising a plurality of first level signal lines, wherein each first level signal line is provided for at least two pixels of the image sensor, thereby defining a first level pixel tile; and a plurality of second level signal lines, wherein each second level signal line is provided for at least two first level pixel tiles of the image sensor, thereby defining a second level pixel tile, the method comprising: generating an activation signal for activating the second level pixel tile, as discussed herein.

The image sensor control method may be carried out on image sensor control circuitry and/or on an image sensor according to the present disclosure.

In some embodiments, the method further includes: deactivating a single pixel of the first level pixel tile for further defining the second level pixel tile, as discussed herein. In some embodiments, the method further includes: generating a definition signal for defining the second level pixel tile, as discussed herein.

The methods as described herein are also implemented in some embodiments as a computer program causing a computer and/or a processor to perform the method, when being carried out on the computer and/or processor. In some embodiments, also a non-transitory computer-readable recording medium is provided that stores therein a computer program product, which, when executed by a processor, such as the processor described above, causes the methods described herein to be performed.

Returning to FIG. 1, on the left, there is shown a first level pixel tile 1 including four (single) pixels (top left), which can be in an active state or in an inactive state, as shown under reference of the first level pixel tile 1′ (bottom left), which includes two active pixels 2 and two inactive pixels 3, thereby saving power.

The respective signals of the four single pixels are always combined with a logic function (e.g., OR, XOR, NOR, AND, or the like). In this embodiment, the combining logic is configured to be insensitive to deactivated pixels. For example, if AND is the logic function, this would mean that all pixels would need to supply a signal to the combining logic. However, in this embodiment, the deactivated pixels are not taken into account for the combining logic. For example, if AND is used, non-active pixels may need to constantly give “1” as an output. If OR is used, the non-active pixels may need to constantly give “0” as an output. For XOR which is used with toggling pixels, either a constant “1” or a constant “0” may be needed to indicative inactive pixels.

Moreover, FIG. 1 depicts, on the upper right, a second level pixel tile 4 including four first level pixel tiles 1. The second level pixel tile is indicated with a dashed line. Moreover, a second level pixel tile signal line node 5 of a first type is shown in the middle of the four first level pixel tiles, wherein the second level pixel tile signal line node 5 is connectable to a second level pixel tile signal line, as discussed herein, such that the second level pixel tile 5 can be read out.

Furthermore, on the bottom right, an embodiment of an image sensor 6 is shown which, for illustrational purposes, is based on a grid of three times three first level pixel tiles 1. The nine first level pixel tiles 1 are grouped as four different overlapping second level pixel tiles 7, 8, 9, and 10.

The second level pixel tiles 7 and 8 are defined by the second level pixel tile signal line node 5. For illustrational purposes, the second level pixel tiles 7 and 8 are marked with dashed lines, which are also depicted below the illustration of the sensor 6.

The second level pixel tiles 9 and 10 are defined by a second level pixel tile signal line node 11 of a second type (which has a different hatching than the second level pixel tile signal line node 5, such that they can be distinguished). For illustrational purposes, the second level pixel tiles 9 and 10 are marked with pointed lines, which are also depicted below the illustration of the sensor 6.

For example, the second level pixel tiles 7 to 10 may be read out separately and/or may define one third level pixel tile, as discussed herein.

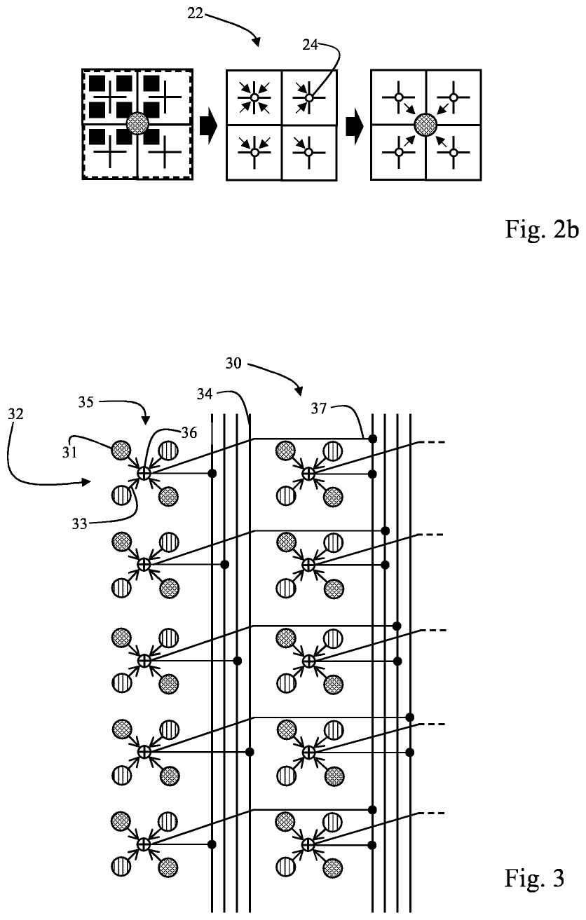

FIG. 2a depicts a further embodiment of an image sensor 20 including a plurality of first level pixel tiles 1 and a plurality of second level pixel tile nodes, similar to the sensor 6 of FIG. 1, such that a repetitive description thereof, is omitted.

FIG. 2a depicts a situation in which a region of interest (ROI) is to be imaged. According to the present disclosure, an ROI is referred to as a macro pixel. Hence, based on defining the respective levels of pixel tiles, dynamically adaptable macro pixels may be realized. Moreover, multiple macro pixels may be defined simultaneously by overlapping pixel tiles.

In the present of embodiment of FIG. 2a, a subset 21 of the single pixels of the image sensor 20 should only be active. In FIG. 2a, these active pixels 21 are marked in black. In this embodiment, it is sufficient to activate a second level pixel tile 22 (framed with a dashed line) with a second level pixel tile signal line node 23, while pixels of the second level pixel tile 22 that shall not be active are deactivated.

The second level pixel tile 22 is further depicted in FIG. 2b. It should be noted that the “steps” indicated in FIG. 2b are depicted for illustrational purposes only.

On the left, the ROI is shown as in FIG. 2a. The illustration in the middle of FIG. 2b shows how pixel signals (indicated with arrows) are acquired by first level pixel tile nodes 24. On the right, it is shown how pixels from the first level pixel tiles 1 are acquired by the second level pixel tile node 5, as already discussed herein.

FIG. 3 depicts a combination system 30 according to the present disclosure. In this embodiment, every two times two second level pixel tile 31 defines one third level pixel tile 32. From the second level pixel tiles, signal lines 33 (third level signal lines; indicated with arrows) connect the second level pixel tiles with a third level pixel tile node 36. Moreover, the third level pixel tile node 33 is connected with vertical readout lines 34.

It should be understood that the second level pixel tiles 31 include four (two-times-two) first level pixel tiles, as described under reference of FIG. 2.

In this embodiment, next to each third level pixel tile column 35, four vertical readout lines 34 are provided, and adjacent third level pixel tiles 32 are connected to the different vertical readout lines 34 in an alternating manner, i.e., an upper third level pixel tile 32 is connected with the left readout line 34, a next (below) third level pixel tile 32 is connected with the readout line 34, which is second from the left, a further below third level pixel tile 32 is connected with the readout line 34 which is third from the left, a further below third level pixel tile 32 is connected with the readout line 34 which is fourth from the left (on the right), and then, a further below third level pixel tile 32 is again connected to the outmost left readout line 34, and so on, without limiting the present disclosure in that regard.

Moreover, each third level pixel tile 32 of the column 35 is further connected to the vertical readout lines provided next to the neighboring column, also in an alternating manner, as described above.

In this embodiment, horizontal bus lines 37 (i.e., the connection of a third level pixel tile with multiple bus lines) are provided for disentangling conflicts and the vertical bus lines deliver the signal to peripheral resources (e.g., TDC).

Moreover, in this embodiment, it is assumed that it is unlikely that neighboring nodes need different bus lines, i.e., macro pixels do not overlap and can thus be separated by few pixels, such that it is possible to introduce the third hierarchy level (i.e., the third level pixel tiles) with the objective to reduce the bus width/size or load.

The bus may be determined by a bus width parameter N_{bus}_{_{_}}ₕ for the horizontal bus lines and by a bus width parameter N_{bus}_{_{_}}_{y} for the vertical bus lines. In this embodiment, a bus line allocation pattern repeats every N_{bus}_{_{_}}ᵥ rows. For each third level pixel tile, it may be decided which horizontal bus line is used, such that the signal of the respective third level pixel tile may be redirected to that line. Hence, potential conflicts if two or more third level macro pixels are on the same vertical direction (for different third level pixel tiles which are roughly N_{bus}_{_{_}}ᵥ numbers spaced apart from each other) can be disentangled with the horizontal bus lines.

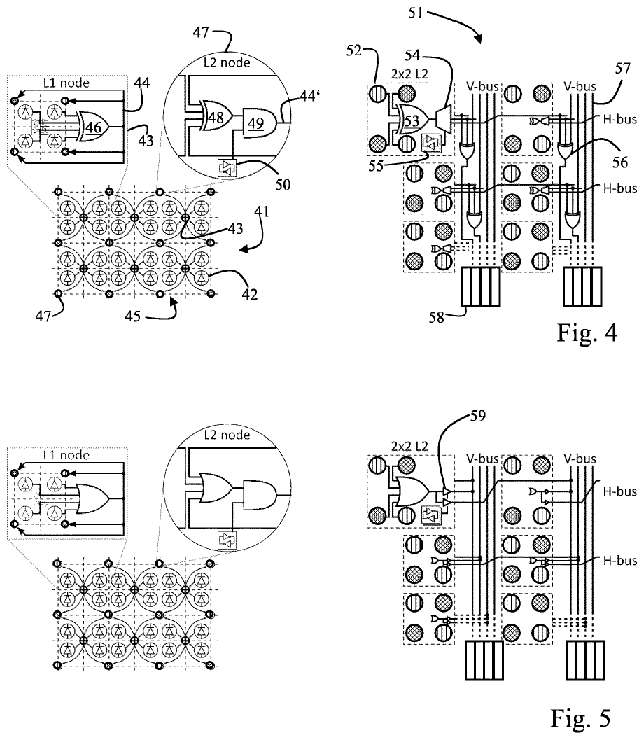

FIG. 4 depicts an embodiment of an image sensor 41 and of image sensor control circuitry according to the present disclosure.

On the bottom left, a schematic view of an image sensor 41 is shown including a plurality of toggling SPAD-based single pixels 42, which form first level pixel tiles and second level pixel tiles, as described herein.

The SPAD-based single pixels 42 are connected, via first level signal line nodes 43 (also referred to as L1 node), to first level signal lines 44, thereby establishing/defining first level pixel tiles 45. Moreover, the first level pixel tiles 42 are connected to the first level signal line node 43 via an exclusive or (XOR) gate 46, such that a signal is transmitted to the node 44 when single pixel 42 generates a signal.

Moreover, each first level pixel tile 45 is connected with four second level pixel tile line nodes 47, thereby establishing overlapping second level pixel tiles, as described herein. Each second level pixel tile line node 47 (also referred to as L2 node which also includes second level signal lines 44′) is based on an XOR gate 48, similar to the L1 node 43, wherein an output of the XOR gate 48 is connected to an input of a cell 49. Moreover, a configurable memory 50 is connected to an input of the cell 49. The cell 49 is configured to block a signal flow, if the respective L2 node is not chosen as the center of the respective tile, or, in other words to select the respective L2 node.

On the right, FIG. 4 depicts a readout bus 51 for reading out third level pixel tiles 52. It should be noted that the readout bus 51 is similar to the one shown in FIG. 3 and thus, repetitive description of the same elements is omitted.

In contrast to the combination system 30 in FIG. 3, the readout bus 51 depicts logic elements for the third level pixel tiles which is similar to the L2 node 47. Hence, for a two times two grid of second level pixel tiles 47 (which define one third level pixel tile 52), an XOR gate 53 is provided, whose output is connected to a demultiplexer 54, which is connected to a configurable memory 55. The output of the demultiplexer 54 is then connected to a further repeater 56 which is provided in the vertical bus lines 57. Moreover, at the end of each vertical bus line 57, a time to digital converter 58 is provided.

FIG. 5 depicts further embodiment of an image sensor and image sensor control circuitry, which is different from the embodiment of FIG. 4 in that, instead of XOR gates, OR gates are provided. Moreover, instead of the demultiplexer 54, a three-state buffer 59 is provided. The three-state buffer 59 is a logic port that allows an output to be set as an high impedance, to let multiple outputs act on the same wire (bus) but not at the same time, thereby avoiding conflicts. A repetitive description of the remaining components is omitted.

The repeater or three-state approach can be independently applied to both embodiments of FIG. 4 or 5, i.e., the XOR result can be injected into the bus with a three-state buffer or the OR result can be injected in the bus with a OR repeater.

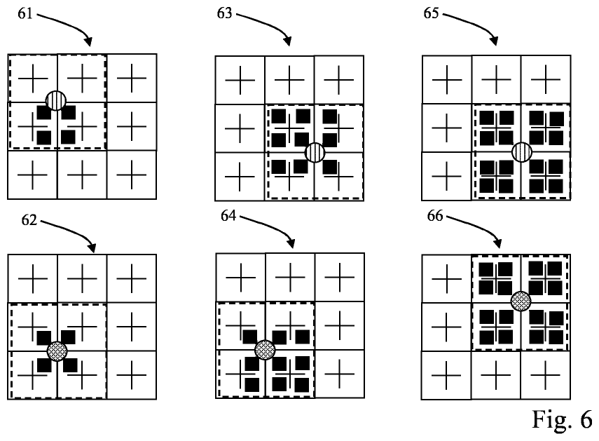

FIG. 6 depicts different pixel tile (level 1/2) tiles corresponding to different macro pixel patterns, which may be achieved according to the present disclosure. For example, different two times two pixels patterns, such as pixel pattern 61 or 62 may be achieved. Also, different three times three pixel patterns, such as pixel patterns 63 or 64 may be achieved. Also different four times four pixel patterns, such as pixel patterns 65 or 66 may be achieved, and so on.

Hence, according to the present disclosure, flexible macro pixel patterns, sizes, and positions may be achieved. Moreover, such macro pixels may be easy to configure. A mapping may be easily determined by the array of selected L2 nodes and the horizontal connection of L3 nodes. For example, it may be sufficient if an L3 node contains such mapping information.

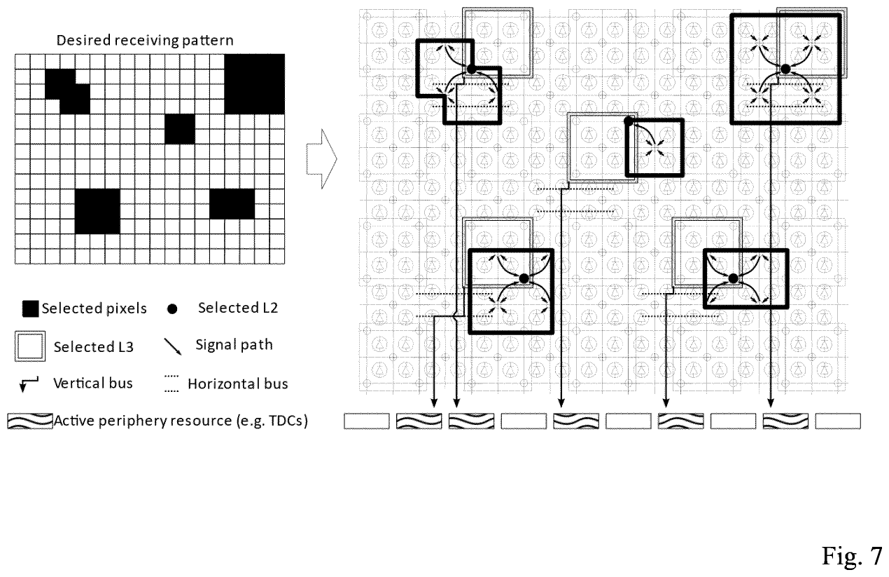

FIG. 7 depicts an image sensor according to the present disclosure. On the left, a desired macro pixel pattern is depicted and on the right, corresponding nodes and circuitry is depicted for achieving the desired macro pixel pattern.

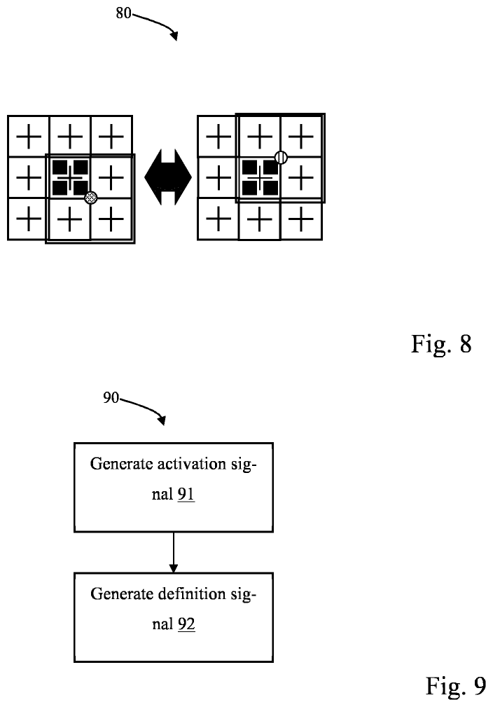

FIG. 8 depicts an image sensor 80 with overlapping second level pixel tiles. In this embodiment, a macro pixel including by four single pixels of a first level pixel tile 1 should be read out. However, due to the overlapping structure of the second level pixel tiles, there are multiple possibilities (of which two are depicted) for reading out the first level pixel tile 1.

In case of a problem of reading out the first level pixel tile 1 with the configuration on the left, it can be decided to use the configuration on the right. Hence, an image sensor or image sensor control circuitry according to the present disclosure has multiple degrees of freedom in which it can be configured.

FIG. 9 depicts an image sensor control method according to the present disclosure which is carried out on image sensor control circuitry according to the present disclosure.

Although not shown, at first, a macro pixel pattern may be determined. The macro pixel pattern may be predefined or it may be actively acquired by the circuitry. The pattern may be determined once or every time an acquisition is to be carried out, e.g., by intensity acquisition, or the like.

Moreover, in this embodiment, it is assumed that all the pixels are reset (deactivated).

At 91, an activation signal is generated which causes an image sensor to activate only those pixels which belong to the determined macro pixel.

At 92, a definition signal for defining the second level pixel tile is generated, i.e., a barycenter for the L2 pixel is thereby defined.

After that, in some embodiments, a bus routing is defined in order to connect the L2 (or L3, if existing) to the proper bus line, thereby avoiding conflicts between macro pixels.

After that, the pixels are read out, in some embodiments.

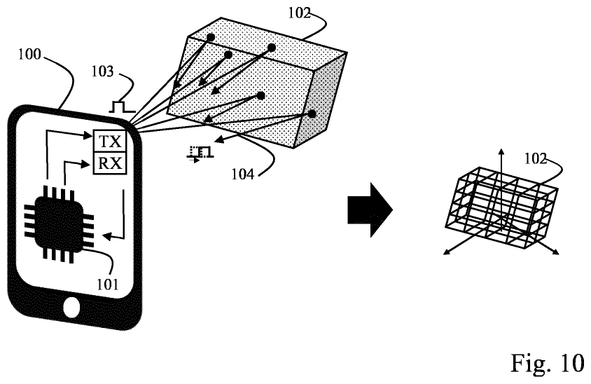

FIG. 10 depicts a schematic view of a smartphone 100 which functions as a time-of-flight camera including an image sensor (RX, receiver) and image sensor control circuitry 101 according to the present disclosure, wherein the image sensor control circuitry 101 is implemented as an application processor (AP).

For acquiring a depth image of the scene, the smart phone further includes a light source (TX, transmitter) which emits modulated light 103, wherein light paths 104 of how the modulated light is emitted and reflected is shown for illustrational purposes.

The application processor 101 is configured to determine which parts of the scene 102 need to be sampled by the dToF camera, based on its current knowledge of the environment (i.e., prediction of movement, missing parts or new portions, need for more precision, disambiguation of untextured or unlit surfaces, or the like).

The AP 101 is further configured to communicate to both TX (transmitter) and RX (receiver) which dots (i.e., macro pixels in the receiver and dots in the transmitter) should be activated, such that a depth image of a reconstructed scene 105 can be obtained.

In an operation example according to the present disclosure which may be implemented as an imaging method according to the present disclosure, the AP 101 may control the light source to shine a given pattern, such as an intensity map. The AP 101 may identify pixels above a given threshold based on the intensity map and based on these pixels, pixel tiles (of different levels) may be defined, such that corresponding pixels according to a pixel pattern may be activated/deactivated by the AP 101.

Based on the desired receiving pattern (i.e., the intensity map), illuminated pixels may be turned on (or not illuminated pixels may be turned off). The pattern does not need to be programmed completely: it is also possible, in some embodiments, to add or remove individual or groups of dots/macro pixels.

All L2 pixels with at least one active L1 pixel may be turned on. The L3 pixels subtending an active L1 are connected to the bus. Conflicting L3 pixels are disentangled with the horizontal bus, as discussed herein. The signal paths indicate how these “arbitrary” shapes can be routed to independent vertical lines.

It should be noted that any implementation different from the AP 101 may be chosen, such as an internal microprocessor, controller, or the like and it may lie within the abilities of the person skilled in the art to perform corresponding changes to remaining parts of the mobile phone 100 without departing from the present disclosure.

It should be noted that the present disclosure is not limited to the case of a smartphone as discussed under reference of FIG. 10. For example, the present disclosure may be applied to a direct time-of-flight receiver for a system with a flexible and reconfigurable dot pattern projection, such as in a smartphone, smart glasses, in augmented/virtual reality applications, automotive application (e.g., LIDAR (e.g., for autonomous driving)), in optical communications applications (e.g., where multichannel laser data transmission is required (e.g., Li-Fi)), in industrial/surveying applications (e.g., dual operation (e.g., ToF/triangulation), spot tracking (e.g., in triangulation-based LIDARs)), or the like.

It should be noted that other combining/logic functions may be possible, for example:

Sum function: the delivered information may include the number of detected photons in the pixel tile and/or macro pixel within a certain amount of time.

Correlation function: the delivered information may include the moment when the detected photons in the pixel tile and/or macro pixel exceed a given threshold (e.g. 2 photons).

It should be noted that more than one signal line may be used for each pixel tile such that different combinations of function may be realized, such as: Multibit number for count function; OR function plus correlation function; XOR function plus correlation function.

It should be noted that apart from the information described herein, other information may be delivered on the bus lines corresponding to various modalities, for example, based on repeaters (e.g. XOR or OR gates), three-state buffers, or the like.

It should be noted that buses may be duplicated and merged afterwards or before TDCs to avoid too much added delay (in case of repeaters) or too high loading (in case of three-state buffers).

It should be recognized that the embodiments describe methods with an exemplary ordering of method steps. The specific ordering of method steps is however given for illustrative purposes only and should not be construed as binding. For example, the ordering of 91 and 92 in the embodiment of FIG. 9 may be exchanged. Also, the ordering of the steps in the embodiment of FIG. 2b may be exchanged. Other changes of the ordering of method steps may be apparent to the skilled person.

In some embodiments, also a non-transitory computer-readable recording medium is provided that stores therein a computer program product, which, when executed by a processor, such as the processor described above, causes the method described to be performed.

All units and entities described in this specification and claimed in the appended claims can, if not stated otherwise, be implemented as integrated circuit logic, for example on a chip, and functionality provided by such units and entities can, if not stated otherwise, be implemented by software.

In so far as the embodiments of the disclosure described above are implemented, at least in part, using software-controlled data processing apparatus, it will be appreciated that a computer program providing such software control and a transmission, storage or other medium by which such a computer program is provided are envisaged as aspects of the present disclosure.

Note that the present technology can also be configured as described below.
(1) Image sensor control circuitry for controlling a plurality of pixels (1; 7; 8; 9; 10; 22; 31; 32; 42; 47; 52) of an image sensor (6; 20) for defining a macro pixel and routing a signal of the macro pixel to a sensor periphery, the circuitry comprising:
   a plurality of first level signal lines (44), wherein each first level signal line (44) is provided for at least two pixels (42) of the image sensor (6; 20), thereby defining a first level pixel tile (1); and
   a plurality of second level signal lines (44′), wherein each second level signal line (44′) is provided for at least two first level pixel tiles (1) of the image sensor (6; 20), thereby defining a second level pixel tile (7; 8; 9; 10; 22; 31; 47).
(2) The image sensor control circuitry of (1), configured to:
   generate an activation signal for activating the second level pixel tile (7; 8; 9; 10; 22; 31; 47).
(3) The image sensor control circuitry of (1) or (2), further comprising:
   a plurality of third level signal lines (33), wherein each third level signal line (33) is provided for at least two second level pixel tiles (7; 8; 9; 10; 22; 31; 47) of the image sensor (6; 20), thereby defining a third level pixel tile (32; 52).
(4) The image sensor control circuitry of anyone of (1) to (3), configured to:
   at least one of activate and deactivate at least one single pixel (42) of the first level pixel tile (1) for further defining the second level pixel tile (7; 8; 9; 10; 22; 31; 47).
(5) The image sensor control circuitry of anyone of (1) to (4), configured to:
   generate a definition signal for defining the second level pixel tile (7; 8; 9; 10; 22; 31; 47).
(6) The image sensor control circuitry of (5), wherein the definition signal is based on a logic function.
(7) The image sensor control circuitry of anyone of (1) to (6), wherein the first level signal lines (44) and the second level signal lines (44′) constitute a combination system.
(8) The image sensor control circuitry of (7), further comprising first level combination circuitry (46) and second level combination circuitry (48, 49) being different for the first level signal lines and the second level signal lines.
(9) The image sensor control circuitry (7) of any one of (1) to (8), wherein the second level pixel tiles define overlapping macro pixels.
(10) The image sensor control circuitry (7) of any one of (1) to (9), further comprising horizontal and vertical bus lines configured to resolve possible conflicts between multiple macro pixels.
(11) An image sensor comprising:
   a plurality of pixels (1; 7; 8; 9; 10; 22; 31; 32; 42; 47; 52);
   a plurality of first level signal line nodes (43) for connecting at least two pixels (42) of the plurality of pixels (1; 7; 8; 9; 10; 22; 31; 32; 42; 47; 52) with first level signal lines (44), thereby defining a first level pixel tile (1); and
   a plurality of second level signal line nodes (5; 23; 31; 47) for connecting at least two first level pixel tiles (1) with second level signal lines (44′), thereby defining a second level pixel tile (7; 8; 9; 10; 22; 31; 47).
(12) The image sensor of (11), further comprising:
   image sensor control circuitry (70) for controlling a plurality of pixels (1; 7; 8; 9; 10; 22; 31; 32; 42; 47; 52) of the image sensor (6; 20), the circuitry including:
   a plurality of the first level signal lines (44); and
   a plurality of second level signal lines (44′).
(13) The image sensor of (12), configured to:
   generate an activation signal for activating the second level pixel tile (7; 8; 9; 10; 22; 31; 47).
(14) The image sensor of (12) or (13), wherein the first level signal lines (44) and the second level signal lines (44′) constitute a combination system.
(15) The image sensor of (14), further comprising first level combination circuitry (46) and second level combination circuitry (48, 49) being different for the first level signal lines and the second level signal lines.
(16) The image sensor of anyone of (12) to (15), further comprising:
   a plurality of third level signal line nodes (36), wherein each third level signal line node is provided for at least two second level pixel tiles (7; 8; 9; 10; 22; 31; 47) of the image sensor (6; 20), thereby defining a third level pixel tile (32; 52); and
   a plurality of third level signal lines (33) for connecting the at least two second level pixel tiles (7; 8; 9; 10; 22; 31; 47) with the third level signal line node (36).
(17) The image sensor of anyone of (12) to (16), configured to:
   at least one of activate and deactivate at least one single pixel (42) of the first level pixel tile (1) for further defining the second level pixel tile (7; 8; 9; 10; 22; 31; 47).
(18) The image sensor of anyone of (12) to (17), configured to:
   generate a definition signal for defining the second level pixel tile (7; 8; 9; 10; 22; 31; 47).
(19) The image sensor of (18), wherein the definition signal is based on a logic function.
(20) The image sensor (7) of any one of (11) to (19), wherein the second level pixel tiles define overlapping macro pixels.
(21) The image sensor control circuitry (7) of any one of (11) to (20), further comprising horizontal and vertical bus lines configured to resolve possible conflicts between multiple macro pixels.
(22) An image sensor control method for controlling a plurality of pixels (1; 7; 8; 9; 10; 22; 31; 32; 42; 47; 52) of an image sensor (6; 20) for defining a macro pixel and routing a signal of the macro pixel to a sensor periphery, the method being carried out with image sensor control circuitry (70) comprising a plurality of first level signal lines (44), wherein each first level signal line (44) is provided for at least two pixels (42) of the image sensor (6; 20), thereby defining a first level pixel tile (1); and a plurality of second level signal lines (44′), wherein each second level signal line (44′) is provided for at least two first level pixel tiles (1) of the image sensor (6; 20), thereby defining a second level pixel tile (7; 8; 9; 10; 22; 31; 47), the method comprising:
   generating (91) an activation signal for activating the second level pixel tile (7; 8; 9; 10; 22; 31; 47).
(23) The method of (22), further comprising:
   at least one of activating and deactivating (93) a single pixel (42) of the first level pixel tile (1) for further defining the second level pixel tile (7; 8; 9; 10; 22; 31; 47).
(24) The method of (22) or (23), further comprising: generating (92) a definition signal for defining the second level pixel tile (7; 8; 9; 10; 22; 31; 47).
(25) A computer program comprising program code causing a computer to perform the method according to anyone of (22) to (24), when being carried out on a computer.
(26) A non-transitory computer-readable recording medium that stores therein a computer program product, which, when executed by a processor, causes the method according to anyone of (22) to (24) to be performed.

1. Image sensor control circuitry for controlling a plurality of pixels of an image sensor for defining a macro pixel and routing a signal of the macro pixel to a sensor periphery, the circuitry comprising:
a plurality of first level signal lines, wherein each first level signal line is provided for at least two pixels of the image sensor, thereby defining a first level pixel tile; and
a plurality of second level signal lines, wherein each second level signal line is provided for at least two first level pixel tiles of the image sensor, thereby defining a second level pixel tile.

2. The image sensor control circuitry of claim 1, configured to:
generate an activation signal for activating the second level pixel tile.

3. The image sensor control circuitry of claim 1, further comprising:
a plurality of third level signal lines, wherein each third level signal line is provided for at least two second level pixel tiles of the image sensor, thereby defining a third level pixel tile.

4. The image sensor control circuitry of claim 1, configured to:
at least one of activate and deactivate at least one single pixel of the first level pixel tile for further defining the second level pixel tile.

5. The image sensor control circuitry of claim 1, configured to:
generate a definition signal for defining the second level pixel tile.

6. The image sensor control circuitry of claim 5, wherein the definition signal is based on a logic function.

7. The image sensor control circuitry of claim 3, wherein the first level signal lines and the second level signal lines constitute a combination system.

8. The image sensor control circuitry of claim 7, further comprising first level combination circuitry and second level combination circuitry being different for the first level signal lines and the second level signal lines.

9. An image sensor comprising:
a plurality of pixels;
a plurality of first level signal line nodes for connecting at least two pixels of the plurality of pixels with first level signal lines, thereby defining a first level pixel tile; and
a plurality of second level signal line nodes for connecting at least two first level pixel tiles with second level signal lines, thereby defining a second level pixel tile.

10. The image sensor of claim 9, further comprising:
image sensor control circuitry for controlling a plurality of pixels of the image sensor, the circuitry including:
a plurality of the first level signal lines; and
a plurality of second level signal lines.

11. The image sensor of claim 10, configured to:
generate an activation signal for activating the second level pixel tile.

12. The image sensor of claim 10, wherein the first level signal lines constitute a combination system.

13. The image sensor of claim 12, further comprising first level combination circuitry and second level combination circuitry being different for the first level signal lines and the second level signal lines.

14. The image sensor of claim 10, further comprising:
a plurality of third level signal line nodes, wherein each third level signal line node is provided for at least two second level pixel tiles of the image sensor, thereby defining a third level pixel tile; and
a plurality of third level signal lines for connecting the at least two second level pixel tiles with the third level signal line node.

15. The image sensor of claim 10, configured to:
at least one of activate and deactivate at least one single pixel of the first level pixel tile for further defining the second level pixel tile.

16. The image sensor of claim 10, configured to:
generate a definition signal for defining the second level pixel tile.

17. The image sensor of claim 16, wherein the definition signal is based on a logic function.

18. An image sensor control method for controlling a plurality of pixels of an image sensor for defining a macro pixel and routing a signal of the macro pixel to a sensor periphery, the method being carried out with image sensor control circuitry comprising a plurality of first level signal lines, wherein each first level signal line is provided for at least two pixels of the image sensor, thereby defining a first level pixel tile; and a plurality of second level signal lines, wherein each second level signal line is provided for at least two first level pixel tiles of the image sensor, thereby defining a second level pixel tile, the method comprising:
generating an activation signal for activating the second level pixel tile.

19. The method of claim 18, further comprising:
at least one of activating and deactivating a single pixel of the first level pixel tile for further defining the second level pixel tile.

20. The method of claim 18, further comprising:
generating a definition signal for defining the second level pixel tile.
